(19) United States
(12) Patent Application Publication
(10) Pub. No.: US 2018/0013566 A1
(43) Pub. Date: Jan. 11, 2018

(54) APPARATUS, COMPUTER PROGRAM, AND METHOD FOR SECURELY BROADCASTING MESSAGES

(71) Applicant: Dark Matter L.L.C., Dubai (AE)

(72) Inventors: Alexander Sherkin, Vaughan (CA); Ravi Singh, Toronto (CA); Michael Matovsky, Vaughan (CA)

(21) Appl. No.: 15/202,447

(22) Filed: Jul. 5, 2016

(51) Int. Cl. H04L 9/32; H04L 9/08; H04L 29/06

(52) U.S. Cl. CPC H04L 9/3242; H04L 63/0435; H04L 9/0861; H04L 63/0428; H04L 2209/80

(57) ABSTRACT

An apparatus, computer program, and method are provided for securely broadcasting a message to a plurality of recipient devices. In operation, a message is identified, and the message is encrypted utilizing a first key. A message authentication code (MAC) is generated utilizing a second key that is mathematically coupled to the first key (that is utilized to encrypt the message). The encrypted message is caused to be broadcasted to a plurality of recipient devices, utilizing the MAC.

### FIELD OF THE INVENTION

The present invention relates to security protocols, and more particularly to security protocols for broadcasting messages.

### BACKGROUND

In certain scenarios, a sender who has already established individual sessions with multiple recipients may want to send the same message to such multiple recipients. Further, it may be valuable to have confidence that the same message is actually sent to all of such recipients. It is understood that the broadcast message may not be delivered to some of the recipients. Additionally, it is expected that modified messages will be rejected. Thus, if a recipient receives a broadcast message, this should be the same message that the other recipients receive.

There is thus a need for addressing these and/or other needs of the prior art.

### SUMMARY

An apparatus, computer program, and method are provided for securely broadcasting a message to a plurality of recipient devices. In operation, a message is identified, and the message is encrypted utilizing a first key. A message authentication code (MAC) is generated utilizing a second key that is mathematically coupled to the first key (that is utilized to encrypt the message). The encrypted message is caused to be broadcasted to a plurality of recipient devices, utilizing the MAC.

In a first embodiment, the first key may include an encryption key.

In a second embodiment (which may or may not be combined with the first embodiment), the second key may include a MAC key.

In a third embodiment (which may or may not be combined with the first and/or second embodiments), the first key and the second key may be generated utilizing a third key (e.g. a broadcast key). As an option, the first key and the second key may be generated utilizing the third key via a key derivation function. Further, the third key may be included with the encrypted message to be broadcasted to the plurality of recipient devices. Still yet, the third key may be encrypted. Optionally, the third key may be encrypted differently for each of the plurality of recipient devices (e.g. utilizing different session keys). Even still, a plurality of headers may be generated for each of the plurality of recipient devices each with the differently encrypted third key.

In a fourth embodiment (which may or may not be combined with the first, second, and/or third embodiments), the message may be encrypted utilizing a symmetric encryption algorithm.

In a fifth embodiment (which may or may not be combined with the first, second, third, and/or fourth embodiments), the encrypted message may be caused to be broadcasted to the plurality of recipient devices, by sending the encrypted message to a routing server. As an option, the routing server may be configured for creating separate messages for each of the plurality of recipient devices. Further, each of the separate messages for each of the plurality of recipient devices may include a header specific to the recipient device, the encrypted MAC, and the encrypted message.

In a sixth embodiment (which may or may not be combined with the first, second, third, fourth, and/or fifth embodiments), the message is received by a recipient device, after which an encryption key and a MAC key is generated. Further generated is a MAC, utilizing the MAC key. The MAC is also validated, such that the message may be decrypted utilizing the encryption key, based on the validation.

### BRIEF DESCRIPTION OF THE DRAWINGS

FIG. 1 illustrates a method for securely broadcasting a message to a plurality of recipient devices, in accordance with one embodiment.

FIG. 2 illustrates a system for securely broadcasting a message to a plurality of recipient devices, in accordance with one embodiment.

FIG. 3 illustrates a method for generating messages for being broadcast by a sending device, in accordance with one embodiment.

FIG. 4 illustrates a method for processing and broadcasting messages utilizing a router server, in accordance with one embodiment.

FIG. 5 illustrates a method for processing of each recipient-specific message by a recipient device, in accordance with one embodiment.

FIG. 6 illustrates a network architecture, in accordance with one embodiment.

FIG. 7 illustrates an exemplary system, in accordance with one embodiment.

### DETAILED DESCRIPTION

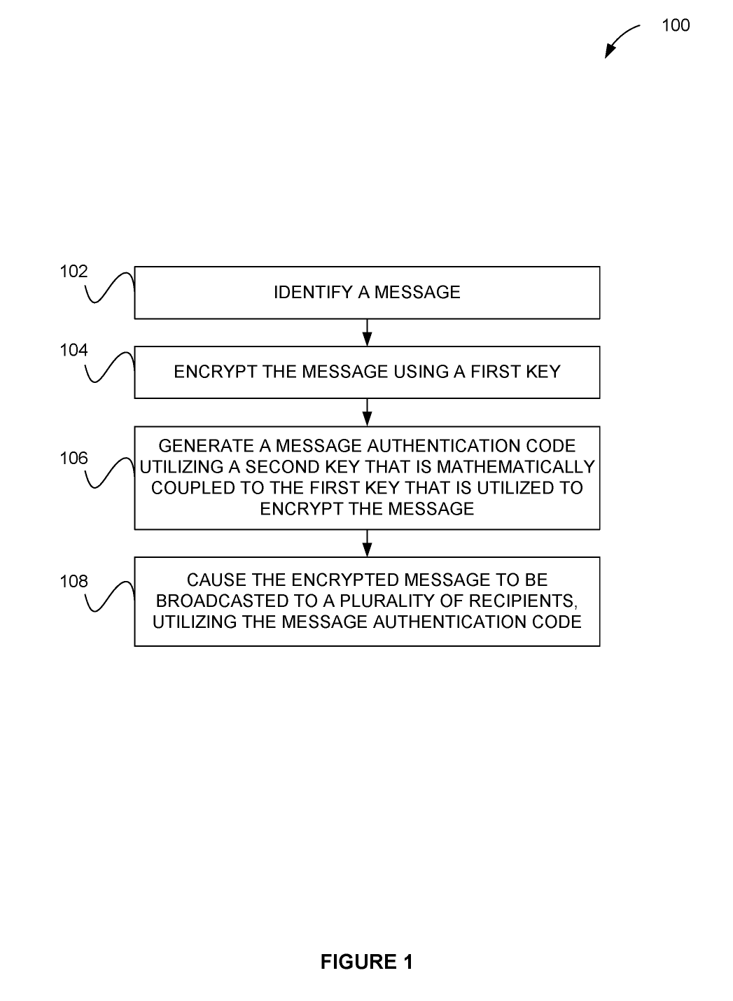

FIG. 1 illustrates a method 100 for securely broadcasting a message to a plurality of recipient devices, in accordance with one embodiment. As shown, in operation 102, a message is identified. In the context of the present description, the message may include any data that is communicated.

Further, in operation 104, the message is encrypted utilizing a first key (e.g. a broadcast key). In various embodiments, the encryption may be carried out utilizing any desired encryption algorithm. For example, such encryption algorithm may include a symmetric encryption algorithm including, but not limited to, the Advanced Encryption Standard (AES), or any other encryption algorithm for that matter.

Moving to operation 106, a message authentication code (MAC) is generated utilizing a second key (e.g. MAC key) that is mathematically coupled to the first key (that is utilized to encrypt the message). In one embodiment, the first key may include an encryption key. Additionally, in the context of the present description, such message authentication code (MAC) may include any code that is capable of validating (e.g. authenticating, etc.) a message upon receipt. For example, in one possible non-limiting embodiment, the MAC may include a hashed message authentication code (HMAC), or any other MAC, for that matter.

Also in the context of the present description, such mathematically coupling may include any relationship whereby it is statistically improbable (to the extent required for reasonable security) that the same MAC code would be generated for a different encryption key. For example, in one embodiment, the MAC key and the encryption key may be generated utilizing another key (e.g. broadcast key) via a key derivation function (KDF). Specifically, in one embodiment, the broadcast key may be generated using any algorithm (e.g. randomly), and the broadcast key may be input into the KDF, in order to generate the MAC key and the encryption key. Such KDF may, in various embodiments, include a key expansion algorithm including, but not limited to, a hashed message authentication code (HMAC)-based KDF (HKDF) algorithm, a cryptographically secure random (or pseudo-random) number generator (CSPRNG) algorithm, etc.

The encrypted message is then caused to be broadcasted to a plurality of recipient devices, utilizing the MAC. See operation 108. In one embodiment, such MAC may be utilized by being included in or in connection with the encrypted message, for validation purposes that will be elaborated upon later during the description of subsequent embodiments.

Further, in one embodiment, the encrypted message may be caused to be broadcasted to the plurality of recipient devices, by sending the encrypted message to a routing server. In the context of the present description, the routing server may include any device that is configured for routing broadcast messages. For example, in one embodiment, the routing server may be configured for creating and sending separate messages for each of the plurality of recipient devices.

In yet another embodiment, the broadcast key may be included with the encrypted message to be broadcasted to the plurality of recipient devices. Still yet, the broadcast key may be encrypted. For example, the broadcast key may be encrypted differently for each of the plurality of recipient devices (e.g. utilizing different session keys). To this end, a plurality of headers may be generated for each of the plurality of recipient devices each with the differently encrypted broadcast key. In the context of a more specific embodiment, each of the separate messages for each of the plurality of recipient devices may thus include a header specific to the recipient device (with the encrypted broadcast key), the encrypted MAC, and the encrypted message.

By this design, upon message recipient in one possible embodiment, the message may be received by a recipient device, after which the encryption key and the MAC key may be re-generated, along with the MAC, utilizing the MAC key. The MAC may also be validated, such that the message may be decrypted utilizing the encryption key, based on the validation.

More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the exclusion of other features described.

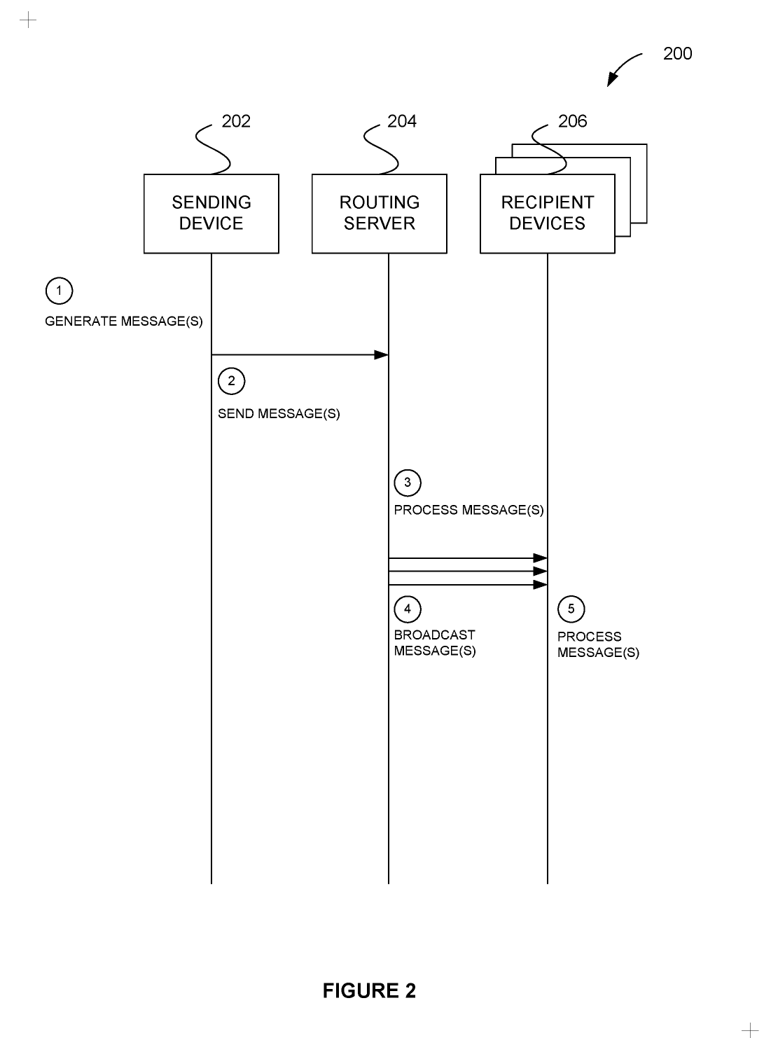

FIG. 2 illustrates a system 200 for securely broadcasting a message to a plurality of recipient devices, in accordance with one embodiment. As an option, the system 200 may be implemented in the context of any one or more of the embodiments set forth in any previous and/or subsequent figure(s) and/or description thereof. However, it is to be appreciated that the system 200 may be implemented in the context of any desired environment.

As shown, a sending device 202, a routing server 204, and a plurality of recipient devices 206 are capable of communication over one or more networks (not shown). Strictly as an option, in one of many possible embodiments, the sending device 202 and the recipient devices 206 may be peer devices that engage in a peer-to-peer protocol such as the one disclosed in U.S. application Ser. No. 15/179,903, filed Jun. 10, 2016, entitled “PEER-TO-PEER SECURITY PROTOCOL APPARATUS, COMPUTER PROGRAM, AND METHOD,” and which is incorporated herein by reference in its entirety for all purposes (hereinafter “Incorporated Application”).

In use, the routing server 204 serves to propagate messages received from the sending device 202 to the recipient devices 206. To support the operation of the routing server 204, a routing database (not shown) may be provided that is capable of communication with the routing server 204. Specifically, such routing database may serve to store data (e.g. message queues, authenticated chat group information, encrypted file transfers, presence information) associated with the recipient devices 206.

With continuing reference to FIG. 2, the sending device 202, at operation 1, generates one or more messages by following a particular security protocol that will be elaborated hereinafter in greater detail. Next, in operation 2, the message(s) are sent to the routing server 204, which, in turn, processes the message(s) in operation 3. After such processing, the routing server 204 broadcasts individual instances of the message(s) to the recipient devices 206 in operation 4. Upon receipt, the recipient devices 206 individually process the corresponding message(s) in operation 5. More information will now be set forth starting with the operation of the sending device 202 in connection with operations 1-2.

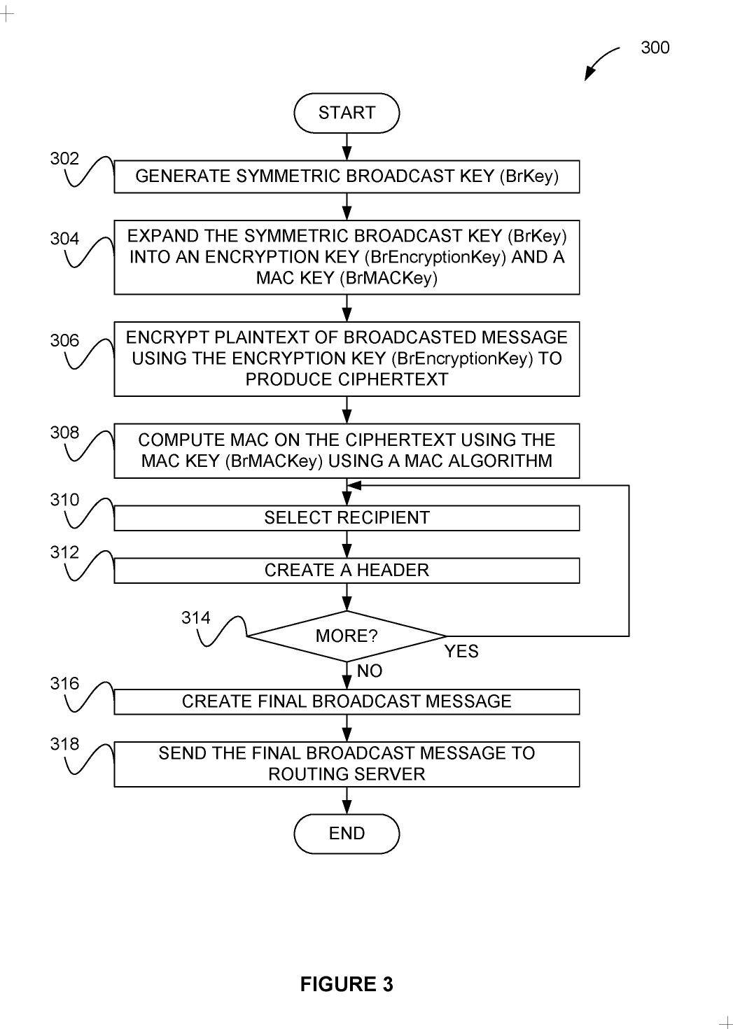

FIG. 3 illustrates a method 300 for generating messages for being broadcasted by a sending device, in accordance with one embodiment. As an option, the method 300 may be implemented in the context of any one or more of the embodiments set forth in any previous and/or subsequent figure(s) and/or description thereof. For example, the method 300 may be implemented in the context of the sending device 202 of FIG. 2 and, in particular, in connection with operations 1-2 of FIG. 2. However, it is to be appreciated that the method 300 may be implemented in the context of any desired environment.

As will become apparent, the method 300 initiates a secure message broadcasting protocol that utilizes existing, established per-recipient device symmetric session keys. Specifically, in one embodiment, it may apply to a situation where a sending device (e.g. the sending device 202 of FIG. 2), hereinafter “sender,” desires to broadcast a secure message to a list of recipient devices (e.g. the recipient devices 206 of FIG. 2), hereinafter “recipient.” For every recipient, the sender has at least one symmetric session key that is associated with a recipient identifier (e.g. SessionKey[RecipientID]).

To accomplish this, in operation 302, the sender generates a symmetric broadcast key (e.g. BrKey) and stores the same in connection with the aforementioned recipient identifier (e.g. SessionKey[RecipientID]). In one embodiment, the symmetric broadcast key may be generated with a random algorithm or any other algorithm, for that matter. For example, in other embodiments, a pseudorandom algorithm may be employed.

Next, in operation 304, an expansion function (e.g. HKDF, CSPRNG) is used to expand the broadcast key (e.g. BrKey) into two additional keys, namely an encryption key (e.g. BrEncryptionKey) and a MAC key (e.g. BrMACKey). As mentioned earlier, this may be accomplished using any desired KDF. In one embodiment, the KDF may derive two additional keys using a pseudo-random function and may even be used to stretch such additional keys into longer keys or convert the same to a required format.

With continuing reference to FIG. 3, the sender then encrypts a plaintext (and/or any other content) of the message using the encryption key (e.g. BrEncryptionKey) using a symmetric encryption algorithm (e.g. AES, etc.) to produce ciphertext [e.g. ciphertext=EBrEncryptionKey(Plaintext)]. See operation 306. As will become apparent, such encryption key (or a derivation/transformation thereof) may be used to not only encrypt the plaintext, but also to decrypt the same.

In operation 308, the sender computes a MAC on the ciphertext using the MAC key (e.g. BrMACKey) via a MAC algorithm (e.g. HMAC), such that MAC=MACBrMACKey(EBrEncryptionKey(Plaintext)). In one embodiment, the HMAC may involve a cryptographic hash function (hence the ‘H’ in HMAC) in combination with a secret cryptographic key. In such an embodiment, the HMAC may be used to simultaneously verify both data integrity and an authentication of a message. Any cryptographic hash function, (e.g. MD5, SHA-1, etc.) may be used in the calculation of the HMAC. In various embodiments, a cryptographic strength of the HMAC may depend upon a cryptographic strength of the underlying hash function, a size of its hash output, and/or a size and/or quality of the key.

The method 300 continues by performing various operations for each of a plurality of recipients that are to receive the message(s). Specifically, a recipient is selected in operation 310 and a specific header is generated for such recipient in operation 312. In one embodiment, such specific header may include the broadcast key, in an encrypted format. As an option, the broadcast key may be encrypted with the aforementioned session key that is unique to the current particular recipient, as follows: H[RecipientID]=ESessionKey[RecipientID](BrKey). Such iterative process continues until there are no further recipients in need of a header per decision 314.

Next, in operation 316, the sender creates a final single message for being sent to a routing server (e.g. routing server 204 of FIG. 2) using an address that is stored for such routing server. See operations 316/318. In one embodiment, the aforementioned final message may include a list of the headers generated in the repeated operation 312, the message ciphertext created in operation 306, and the MAC created in operation 308, as follows: BroadcastMessage={H[RecipientID]}, Ciphertext, MAC. More information will now be set forth regarding the processing of such final single message by the routing server, in accordance with one possible embodiment.

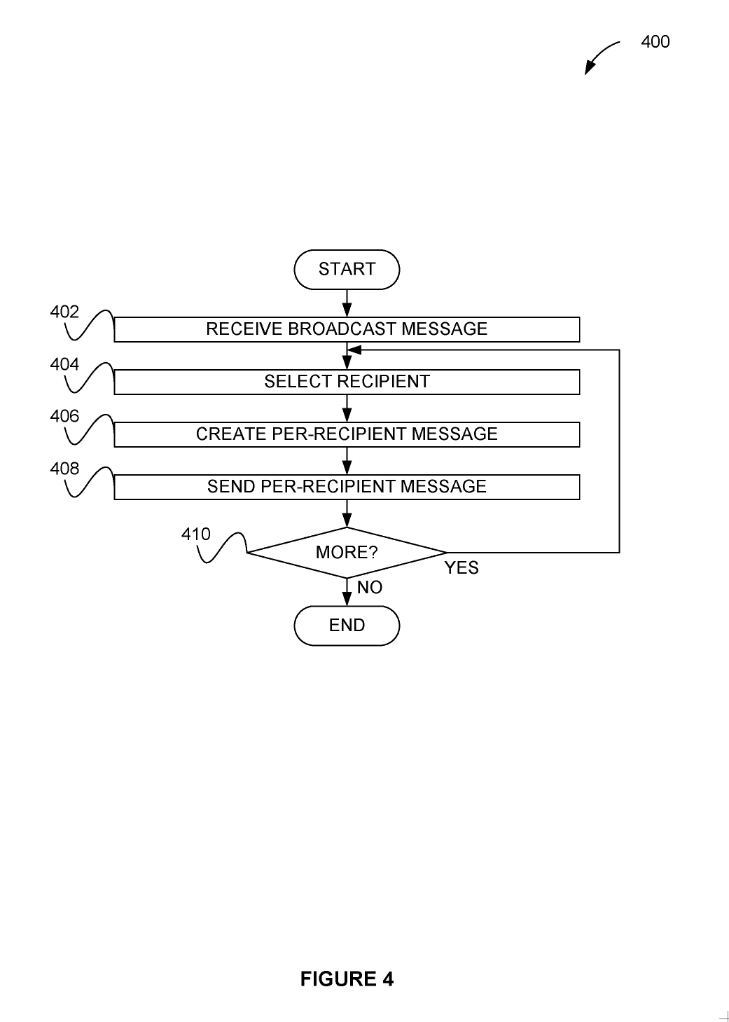

FIG. 4 illustrates a method 400 for processing and broadcasting messages utilizing a router server, in accordance with one embodiment. As an option, the method 400 may be implemented in the context of any one or more of the embodiments set forth in any previous and/or subsequent figure(s) and/or description thereof. For example, the method 400 may be implemented in the context of the routing server 204 of FIG. 2 and, in particular, in connection with operations 3-4 of FIG. 2. However, it is to be appreciated that the method 400 may be implemented in the context of any desired environment.

As shown, the method 400 begins with a receipt of a broadcast message (e.g. the final message generated/send in operations 316/318 of FIG. 3) at a routing sever (e.g. the routing server 204 of FIG. 2). As mentioned earlier, the received broadcast message includes a list of the headers generated for each recipient, the message ciphertext, and the MAC. To this end, the method 400 continues by performing various operations for each of a plurality of recipients that are to receive the message(s).

Specifically, the recipients are each individually selected in operation 404 by processing, one-by-one, each of the headers included in the broadcast message received in operation 402. Further, an individual message for each recipient (e.g. PerRecipientMessage) is created in operation 406. In one embodiment, this may be accomplished by replicating the ciphertext, attaching/encapsulating the recipient-specific header to the ciphertext, and including the MAC, as follows: PerRecipientMessage=H[RecipientID], Ciphertext, MAC.

Once created, the recipient-specific message is sent in operation 408 and operations 404-408 are repeated until all recipient-specific messages are created and sent for each of the headers included in the broadcast message received in operation 402, per decision 410. More information will now be set forth regarding the processing of such recipient-specific messages by each recipient, in accordance with one possible embodiment.

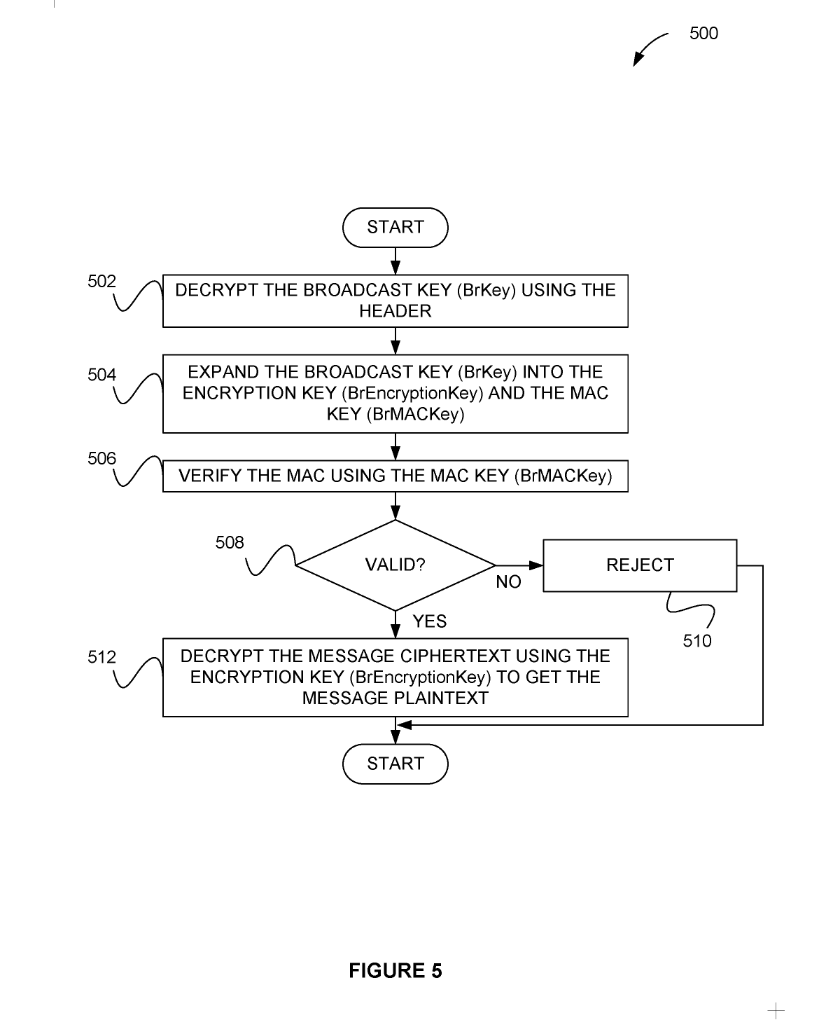

FIG. 5 illustrates a method 500 for processing of each recipient-specific message by a recipient device, in accordance with one embodiment. As an option, the method 500 may be implemented in the context of any one or more of the embodiments set forth in any previous and/or subsequent figure(s) and/or description thereof. For example, the method 500 may be implemented in the context of each of the recipient devices 206 of FIG. 2 and, in particular, in connection with operation 5 of FIG. 2. However, it is to be appreciated that the method 500 may be implemented in the context of any desired environment.

As shown, when a recipient (e.g. recipient device 206 of FIG. 2) receives its specific message (e.g. generated/sent in operation 406/408 of FIG. 4), the recipient decrypts the broadcast key (e.g. BrKey, etc.) using the header (e.g. H[RecipientID]) to gain access to the same. See operation 502. Such algorithm may be the same as that which was used to encrypt the broadcast key (e.g. see method 300 of FIG. 3).

The recipient may then use an expansion function (again, the same as that used earlier) to expand the broadcast key (e.g. BrKey) into two keys, namely the encryption key (e.g. BrEncryptionKey) and the MAC key (e.g. BrMACKey). See operation 504. Further, in operation 506, the recipient verifies the MAC using the MAC key (e.g. BrMACKey).

To accomplish this, the MAC key obtained in operation 504 may be used to generate a MAC (again, using the same algorithm as in operation 308 of FIG. 3). Further, the MAC key obtained in operation 504 may be compared to the MAC included in the message received from the routing server. See decision 508. If there is no match, the message may be rejected in operation 510, and the method 500 may be terminated, the message may be discarded, and/or an error message may be sent back to the sending device/routing server, etc.

If, however, there is a match per decision 508, the recipient may be permitted to decrypt the message ciphertext using the encryption key (e.g. BrEncryptionKey) to obtain the message plaintext. See operation 512. Thus, the recipient may then have access to the message plaintext.

As disclosed in the aforementioned Incorporated Application, one or more embodiments disclosed herein may be employed in connection with an auditing server. In such embodiment, it may be valuable to ensure that the same message is delivered to all recipients, particularly when one of the recipients is the foregoing auditing server that is copied on all message communications, for auditing purposes. In such embodiments, it may be important to ensure that a malicious sender cannot send one message to a receipts device (e.g. peer, etc.), and another message to the auditing server.

When employing one or more embodiments disclosed herein in connection with an auditing sever, a malicious sender may try to create a broadcast key so that a MAC is validated successfully (e.g. by an auditing server, etc.). However decryption would, in such a scenario, fail. Further, the sender may send such broadcast key to one of the recipients (e.g. an auditing server) to try to prevent such recipient from receiving the message. In such a scenario, the sender may give the correct broadcast key to other devices (e.g. peers, etc.). This, however, would result in the malicious sender having to choose both the MAC key and encryption key independently. Further, such an attempt would fail because such two keys are produced from the same broadcast key. In other words, the MAC key is valid if, and only if, the encryption key is valid (subject, in one embodiment, to a statistically insignificant chance of being able to find a different encryption key while maintaining a valid MAC key).

Of course, the various embodiments disclosed herein may be also valuable in other contexts, e.g. administrator-configured user groups. In such context, it may be important to prevent a malicious sender from sending a valid message to some recipients and an invalid message to others without being detected.

For example, in another scenario, a malicious sender may try to send a corrupted header to one of the recipients to prevent such recipient from receiving the message. However, this recipient would be the subject of a failed MAC verification, and the message would be rejected. To this end, a malicious sender cannot send one message to one recipient and another message to another recipient.

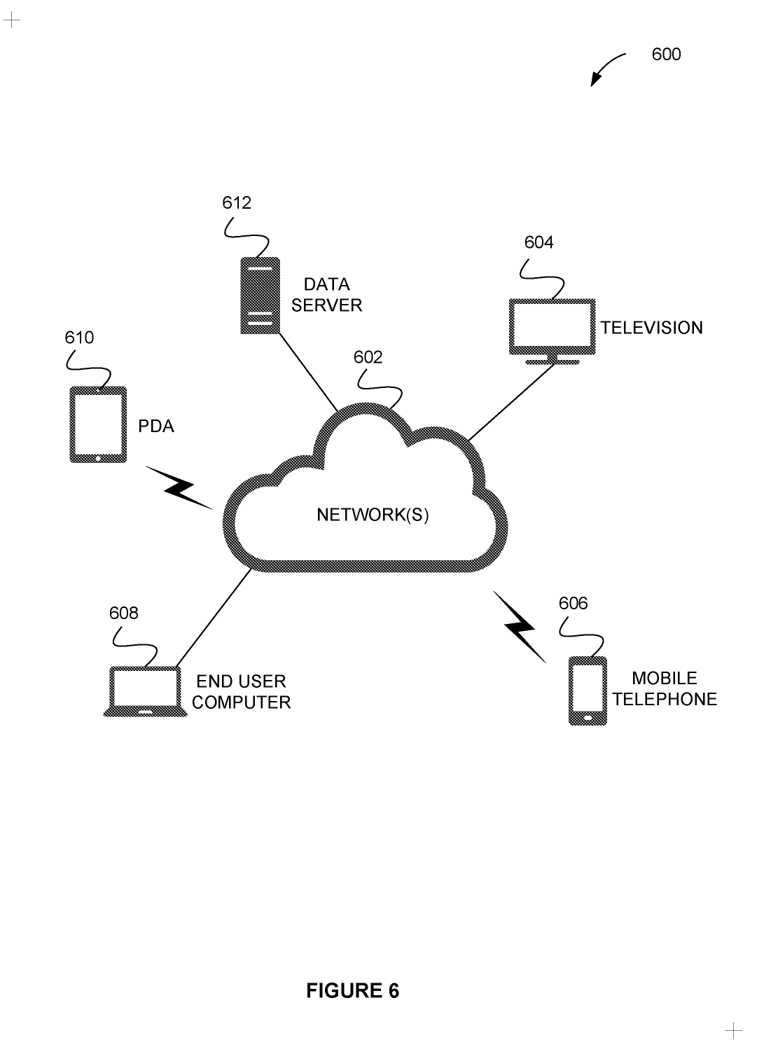

FIG. 6 illustrates a network architecture 600, in accordance with one embodiment. As shown, at least one network 602 is provided. In various embodiments, any one or more components/features set forth during the description of any previous figure(s) may be implemented in connection with any one or more of the components of the at least one network 602.

In the context of the present network architecture 600, the network 602 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 602 may be provided.

Coupled to the network 602 is a plurality of devices. For example, a server computer 612 and an end user computer 608 may be coupled to the network 602 for communication purposes. Such end user computer 608 may include a desktop computer, lap-top computer, and/or any other type of logic. Still yet, various other devices may be coupled to the network 602 including a personal digital assistant (PDA) device 610, a mobile phone device 606, a television 604, etc.

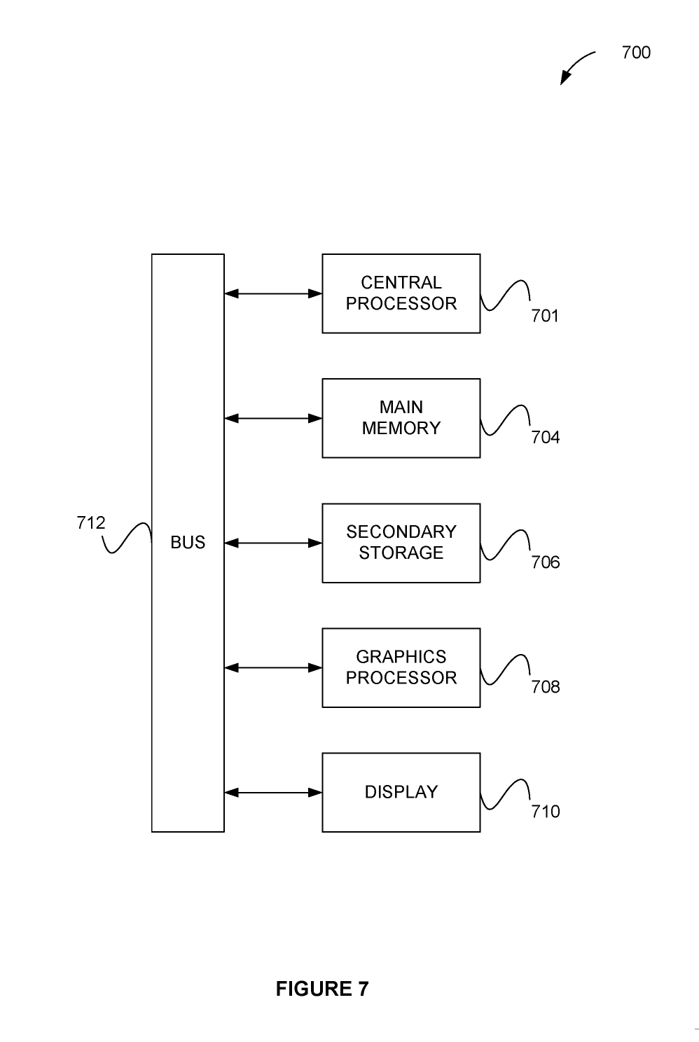

FIG. 7 illustrates an exemplary system 700, in accordance with one embodiment. As an option, the system 700 may be implemented in the context of any of the devices of the network architecture 600 of FIG. 6. However, it is to be appreciated that the system 700 may be implemented in any desired environment.

As shown, a system 700 is provided including at least one central processor 702 which is connected to a bus 712. The system 700 also includes main memory 704 [e.g., hard disk drive, solid state drive, random access memory (RAM), etc.]. The system 700 also includes a graphics processor 708 and a display 710.

The system 700 may also include a secondary storage 706. The secondary storage 706 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 704, the secondary storage 706, and/or any other memory, for that matter. Such computer programs, when executed, enable the system 700 to perform various functions (as set forth above, for example). Memory 704, secondary storage 706 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A computer program product comprising computer executable instructions stored on a non-transitory computer readable medium that when executed by a processor instruct the processor to:
identify a message;
encrypt the message utilizing a first key;
generate a message authentication code utilizing a second key that is mathematically coupled to the first key that is utilized to encrypt the message; and
cause the encrypted message to be broadcasted to a plurality of recipient devices, utilizing the message authentication code.

2. The computer program product of claim 1, wherein the computer program product is further configured such that the first key includes an encryption key.

3. The computer program product of claim 1, wherein the computer program product is further configured such that the second key includes a message authentication code (MAC) key.

4. The computer program product of claim 1, wherein the computer program product is further configured such that the first key and the second key are generated utilizing a third key.

5. The computer program product of claim 4, wherein the computer program product is further configured such that the first key and the second key are generated utilizing the third key via a key derivation function.

6. The computer program product of claim 4, wherein the computer program product is further configured such that the third key includes a broadcast key.

7. The computer program product of claim 4, wherein the computer program product is further configured such that the third key is included with the encrypted message to be broadcasted to the plurality of recipient devices.

8. The computer program product of claim 7, wherein the computer program product is further configured such that the third key is encrypted.

9. The computer program product of claim 8, wherein the computer program product is further configured such that the third key is encrypted differently for each of the plurality of recipient devices.

10. The computer program product of claim 9, wherein the computer program product is further configured such that the third key is encrypted differently for each of the plurality of recipient devices, utilizing different session keys.

11. The computer program product of claim 9, wherein the computer program product is further configured such that a plurality of headers is generated for each of the plurality of recipient devices each with the differently encrypted third key.

12. The computer program product of claim 1, wherein the computer program product is further configured such that the message is encrypted utilizing a symmetric encryption algorithm.

13. The computer program product of claim 1, wherein the computer program product is further configured such that the encrypted message is caused to be broadcasted to the plurality of recipient devices, by sending the encrypted message to a routing server.

14. The computer program product of claim 13, wherein the computer program product is further configured such that the routing server is configured for creating separate messages for each of the plurality of recipient devices.

15. The computer program product of claim 14, wherein the computer program product is further configured such that each of the separate messages for each of the plurality of recipient devices includes a header specific to the recipient device, the encrypted message authentication code, and the encrypted message.

16. An apparatus, comprising:
at least one device configured to:
identify a message;
encrypt the message utilizing a first key;
generate a message authentication code utilizing a second key that is mathematically coupled to the first key that is utilized to encrypt the message; and
cause the encrypted message to be broadcasted to a plurality of recipient devices, utilizing the message authentication code.

17. A method, comprising:
identifying a message;
encrypting the message utilizing a first key;
generating a message authentication code utilizing a second key that is mathematically coupled to the first key that is utilized to encrypt the message; and
causing the encrypted message to be broadcasted to a plurality of recipient devices, utilizing the message authentication code.

18. A computer program product comprising computer executable instructions stored on a non-transitory computer readable medium that when executed by a processor instruct the processor to:
receiving a message;
generating an encryption key and a message authentication code key;
generating a message authentication code utilizing the message authentication code key;
validating the message authentication code; and
decrypting the message utilizing the encryption key, based on the validation.
